(19) United States
(12) Patent Application Publication
(10) Pub. No.: US 2006/0178466 A1
(43) Pub. Date: Aug. 10, 2006

(54) Nanocomposite composition having barrier property

(76) Inventors: Myung Ho Kim, Daejeon-city (KR); Minki Kim, Daejeon-city (KR); Youngtock Oh, Daejeon-city (KR); Sehyun Kim, Daejeon-city (KR); Jaeyong Shin, Daejeon-city (KR); Youngchul Yang, Daejeon-city (KR); Hyung Mann Lee, Seoul (KR)

Correspondence Address: CANTOR COLBURN, LLP, 55 GRIFFIN ROAD SOUTH, BLOOMFIELD, CT, 06002, US

(21) Appl. No.: 11/243,252

(22) Filed: Oct. 4, 2005

(30) Foreign Application Priority Data
Oct. 5, 2004 (KR) 10-2004-0079249
Jun. 2, 2005 (KR) 10-2005-0047122

(51) Int. Cl. C08K 9/04

(52) U.S. Cl. 524/445; 523/216

(57) ABSTRACT

A nanocomposite composition having a barrier property is provided. The compositon is prepared by dry-blending a styrene-based resin, a resin having a barrier property/intercalated clay nanocomposite, and a compatibilizer. The compositon has superior mechanical strength and moldability, and superior oxygen, organic solvent, and moisture barrier properties, and thus can be used to manufacture various articles having a barrier property.

### CROSS-REFERENCE TO RELATED PATENT APPLICATION

This application claims the benefit of Korean Patent Application No. 10-2004-0079249, filed on Oct. 5, 2004, and Korean Patent Application No. 10-2005-0047122, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a composition formed by dry-blending a styrene-based resin, a nanocomposite of an intercalated clay and a resin having a barrier property, and a compatibilizer.

2. Description of the Related Art

Styrene-based resins have superior moldability and dimensional stability. In particular, ABS resin is used in many fields due to a good balance of physical properties such as gloss, electrical property and processibility of styrene and heat resistance, rigidity, oil resistance, weather resistance, and impact resistance of butadiene. However, these resins are limited in their use in packaging or containers for foods, which require superior chemical and oxygen barrier properties. Thus, these resins are used in a multi-layer form with other resins via co-extrusion, lamination or coating.

An ethylene-vinyl alcohol (EVOH) copolymer and polyamide are used in multi-layer plastic products due to their high transparency and superior gas barrier properties. Because these resins are more expensive than general-purpose resins, there has been demand for a resin composition capable of obtaining superior barrier properties even when small amounts of these resins are used.

Meanwhile, when a nano-sized intercalated clay is mixed with a polymer matrix to form a fully exfoliated, partially exfoliated, intercalated or partially intercalated nanocomposite, it has an improved barrier property due to its morphology. Thus, an article having a barrier property manufactured using such a nanocomposite is emerging.

It is very important that the nanocomposite should maintain its morphology having a barrier property even after being molded.

### SUMMARY OF THE INVENTION

The present invention provides a nanocomposite composition having superior mechanical strength and moldability, and superior oxygen, organic solvent, and moisture barrier properties, and capable of maintaining its morphology having a barrier property even after being molded.

The present invention also provides an article manufactured by molding the nanocomposite composition having a barrier property.

According to an aspect of the present invention, there is provided a dry-blended composition including: 40 to 98 parts by weight of a styrene-based resin; 0.5 to 60 parts by weight of at least one nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite and a polyvinylalcohol/intercalated clay nanocomposite; and 1 to 30 parts by weight of a compatibilizer.

In an embodiment of the present invention, the styrene-based resin may be polystyrene (PS), styreneacrylonitrile (SAN) resin or acrylonitrile-butadiene-styrene (ABS) resin.

The weight ratio of the resin having a barrier property to the intercalated clay in the nanocomposite is 58.0:42.0 to 99.9:0.1, and preferably 85.0:15.0 to 99.0:1.0. If the weight ratio of the resin having a barrier property to the intercalated clay is less than 58.0:42.0, the intercalated clay agglomerates and dispersing is difficult. If the weight ratio of the resin having a barrier property to the intercalated clay is greater than 99.9:0.1, the improvement in the barrier property is negligible.

In another embodiment of the present invention, the intercalated clay may include at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one material selected from the group consisting of a modified ABS resin having a functional group that can react with an amide group (—CO—NH), a styrene-maleimide copolymer and an epoxy modified polystyrene copolymer.

According to another aspect of the present invention, there is provided an article manufactured by molding the nanocomposite composition.

In an embodiment of the present invention, the article may be a container, film, pipe, or sheet.

### DETAILED DESCRIPTION OF THE INVENTION

The present invention will now be explained in more detail.

A dry-blended nanocomposite composition having a barrier property according to an embodiment of the present invention include: 40 to 98 parts by weight of a styrene-based resin; 0.5 to 60 parts by weight of at least one nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite and a polyvinylalcohol/intercalated clay nanocomposite; and 1 to 30 parts by weight of a compatibilizer.

The styrene-based resin may be polystyrene (PS), styreneacrylonitrile (SAN) resin or acrylonitrile-butadiene-styrene (ABS) resin. Examples of polystyrene include a general-purpose polystyrene (GPPS) and a high impact polystyrene (HIPS).

The content of the styrene-based resin is preferably 40 to 98 parts by weight, and more preferably 70 to 96 parts by weight. If the content of the styrene-based resin is less than 40 parts by weight, molding is difficult. If the content of the styrene-based resin is greater than 98 parts by weight, the barrier property is poor.

When the styrene-based resin is used in a continuous phase, molding of an article is easy.

The nanocomposite can be prepared by blending an intercalated clay and at least one resin having a barrier property selected from the group consisting of an EVOH copolymer, a polyamide, an ionomer and a polyvinyl alcohol (PVA).

The intercalated clay is preferably an organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult.

The organic material has at least one functional group selected from the group consisting of from primary ammonium to quaternary ammonium, phosphonium, maleate, succinate, acrylate, benzylic hydrogen, dimethyldistearylammonium, and oxazoline.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, oxazoline and dimethyldistearylammonium.

If an ethylene-vinyl alcohol copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably 3 to 30 parts by weight. If the content of the nanocomposite is less than 0.5 part by weight, an improvement of a barrier property is negligible. If the content of the nanocomposite is greater than 60 parts by weight, processing is difficult.

When the intercalated clay is more finely exfoliated in the resin having a barrier property, the nanocomposite can exhibit a better barrier property. The intercalated clay finely exfoliated in the resin forms a barrier film, which improves the barrier property and mechanical properties of the resin and ultimately improves the barrier property and mechanical properties of the nanocomposite composition. Thus, in the present invention, the resin having a barrier property and the intercalated clay are blended to disperse a nano-sized intercalated clay in the resin, thereby maximizing a contact area of the resin and the intercalated clay to prevent permeation of gas and liquid.

The compatibilizer improves the compatibility of the styrene-based resin with the nanocomposite to form a stable composition.

The compatibilizer may be at least one compound selected from the group consisting of a modified ABS resin having a functional group that can react with an amide group (—CO—NH), a styrene-maleimide copolymer, and an epoxy-modified polystyrene copolymer, or a mixture thereof.

When an epoxy-modified polystyrene copolymer is used as the compatibilizer, a copolymer comprising a main chain which comprises 70 to 99 parts by weight of styrene and 1 to 30 part by weight of an epoxy compound represented by Formula (1), and branches which comprise 1 to 80 parts by weight of acrylic monomers represented by Formula (2), is preferable.

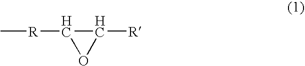

where each of R and R′ is independently a C₁-C₂₀ aliphatic residue or a C₅-C₂₀ aromatic residue having double bonds at its termini

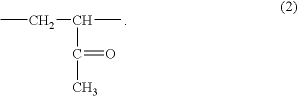

The modified ABS resin is obtained by copolymerizing an aromatic vinyl compound, a vinyl cyanide, and an alkyl ester acrylate in the presence of a conjugated diene-based rubber. The conjugated diene-based rubber may be at least one material selected from the group consisting of a polybutadiene, a random or block copolymer of styrene-butadiene, an acrylonitrile-butadiene copolymer, and a butadiene-isoprene copolymer. Preferably, a polybutadiene or a butadiene-styrene copolymer may be used.

The aromatic vinyl compound may be at least one material selected from the group consisting of styrene, alpha-methylstyrene, vinylxylene, monochlorostyrene, dichlorostyrene, monobromostyrene, dibromostyrene, t-butylstyrene, ethylstyrene, vinyl naphthalene and o-methylstyrene. Preferably, styrene may be used.

The vinyl cyanide may be acrylonitrile.

The alkyl ester acrylate may be at least one material selected from the group consisting of methyl methacrylate, methyl acrylate, ethyl acrylate, hexyl acrylate, propyl acrylate, butyl acrylate, dodecyl acrylate, phenyl acrylate, benzyl acrylate, ethyl methacrylate, butyl methacrylate, hexyl methacrylate, amyl methacrylate, 2-ethylhexyl methacrylate, cyclohexyl methacrylate, dodecyl methacrylate, phenyl methacrylate, and bezyl methacrylate.

Examples of the modified ABS resin include methylmethacrylonitrile butadiene styrene, acrylonitrile butadiene methacrylic methylstyrene, etc. These resins are prepared by graft copolymerizing monomers in the presence a rubbery polymer obtained by emulsion polymerization using an emulsifier and a polymerization initiator. That is, the resins are prepared by blending a butadiene-based synthetic rubber and an acrylonitrile-styrene copolymer grafted with acrylic ester, or by graft copolymerizing acrylonitrile-styrene grafted with acrylic ester to a polybutadiene backbone using an emulsifier and a polymerization initiator.

The content of the compatibilizer is preferably 1 to 30 parts by weight, and more preferably 2 to 15 parts by weight. If the content of the compatibilizer is less than 1 part by weight, the mechanical properties of a molded article from the composition are poor. If the content of the compatibilizer is greater than 30 parts by weight, the molding of the composition is difficult.

The nanocomposite composition of the present invention is prepared by dry-blending the nanocomposite having a barrier property in a pellet form, the compatibilizer and the styrene-based resin at a constant compositional ratio in a pellet mixer.

Then, the prepared nanocomposite composition is pelletized and molded to obtain an article having a barrier property.

That is, the nanocomposite composition is molten-blended in an extruder to form a pellet maintaining a barrier property. When the pellet maintaining a barrier property is formed, the extrusion temperature and the L/D ratio of the extruder are particularly important. The extrusion temperature is generally 160 to 270° C., and may vary according to the type of resin. For example, the extrusion temperature is 190 to 210° C. for ethylenevinylalcohol and 240 to 265° C. for polyamide. When the extrusion temperature is less than 160° C., processing is difficult due to overload of the extruder. When the extrusion temperature is greater than 270° C., physical properties of the pellet is reduced, which is not preferable.

The L/D ratio of the extruder is preferably 30 or less, and more preferably 20 or less. When the L/D ratio is greater than 30, it is difficult to maintain barrier morphology of the nanocomposite due to excessive molten-blending.

The pelletized nanocomposite is molded to prepare an article having a barrier property.

The molded article may be obtained by a general molding method including blowing molding, extrusion molding, pressure molding and injection molding.

The article having a barrier property may be a container, sheet, pipe or film.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 300 (KP Chemicals)

Styrene-based resin: ABS RS-800 (LG CHEM)

Compatibilizer: Modified ABS resin prepared in Preparation Example 1

Clay: Closite 30B (SCP)

Thermal stabilizer: IR 1098 (Songwon Inc.)

### Preparation Example 1

(Preparation of Modified ABS Resin)

100 parts by weight of a monomer mixture containing acrylonitrile, styrene and methyl methacrylate and 105 parts by weight of water were put in a reactor and heated to 70° C. using butadiene latex as a seed in a batch way under nitrogen atmosphere. A first monomer phase containing 0.6 part by weight of t-dodecylmercaptan, 0.5 part by weight of sodium stearate, and 0.5 part by weight of potassium persulfite and a solution containing 0.1 part by weight of potassium persulfate in 50 parts by weight of water were separately added to the mixture and first polymerization was performed for 3 hours. Subsequently, a second monomer phase containing 0.6 part by weight of t-dodecylmercaptan and a solution containing 0.1 part by weight of potassium persulfate in 50 parts by weight of water were separately added to the reaction mixture and second polymerization was performed for 3 hours. After the reaction was completed, the reactor was maintained at 70° C. for 2 hours to terminate the polymerization. 3 parts by weight of aluminum sulfate was added to the resulting resin to salt out. The resultant was filtered, washed, and dried to obtain a modified ABS resin.

### Preparation Example 2

(Preparation of EVOH/lntercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; φ40). Then, 3 wt % of organic montmorillonite (Southern Intercalated Clay Products, USA; Closite 2OA) as an intercalated clay and 0.1 part by weight of IR 1098 as a thermal stabilizer based on total 100 parts by weight of the EVOH copolymer and the organic montmorillonite were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 30 kg/hr.

### Preparation Example 3

(Preparation of Nylon 6/Intercalated Clay Nanocomposite)

97 wt % of a polyamide (nylon 6) was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on total 100 parts by weight of the polyamide and the organic montmorillonite were separately put in the side feeder of the twin screw extruder to prepare a nylon 6/intercalated clay nanocomposite in a pellet form. The extrusion temperature condition was 220-225-245-245-245-245-245° C., the screws were rotated at 300 rpm, and the discharge condition was 40 kg/hr.

### Example 1

30 parts by weight of the EVOH nanocomposite prepared in the Preparation Example 2, 4 parts by weight of a compatibilizer, and 66 parts by weight of the styrene-based resin prepared in the Preparation Example 1 were dry-blended in a double cone mixer (MYDCM-100, MYEONG WOO MICRON SYSTEM) for 30 minutes and put in an extrusion-molding machine (manufactured in the laboratory, L/D=20). Under the extrusion temperature condition of 210-225-235-235° C., the extrusion-molding process was performed to manufacture a 0.8 mm thick sheet.

### Example 2

30 parts by weight of the Nylon 6 nanocomposite prepared in the Preparation Example 3, 4 parts by weight of a compatibilizer, and 66 parts by weight of the styrene-based resin prepared in the Preparation Example 1 were blended in a double cone mixer (MYDCM-100, MYEONG WOO MICRON SYSTEM) for 30 minutes and put in an extrusion-molding machine (manufactured in the laboratory, 25 L/D=10). Underthe extrusion temperature condition of 210-225-235-235° C., the extrusion-molding process was performed to manufacture a 0.8 mm thick sheet.

### Example 3

4 parts by weight of the Nylon 6 nanocomposite prepared in the Preparation 30 Example 3, 2 parts by weight of a compatibilizer, and 94 parts by weight of the styrene-based resin prepared in the Preparation Example 1 were blended in a double cone mixer (MYDCM-100, MYEONG WOO MICRON SYSTEM) for 30 minutes and put in an extrusion-molding machine (manufactured in the laboratory, L/D=10). Underthe extrusion temperature condition of 210-225-235-235° C., the extrusion-molding process was performed to manufacture a 0.8 mm thick sheet.

### Example 4

45 parts by weight of the Nylon 6 nanocomposite prepared in the Preparation Example 3,15 parts by weight of a compatibilizer, and 60 parts by weight of the styrene-based resin prepared in the Preparation Example 1 were blended in a double cone mixer (MYDCM-100, MYEONG WOO MICRON SYSTEM) for 30 minutes and put in an extrusion-molding machine (manufactured in the laboratory, L/D=10). Under the extrusion temperature condition of 210-225-235-235° C., the extrusion-molding process was performed to manufacture a 0.8 mm thick sheet.

### Example 5

45 parts by weight of the Nylon 6 nanocomposite prepared in the Preparation Example 3,15 parts by weight of a compatibilizer, and 60 parts by weight of the styrene-based resin prepared in the Preparation Example 1 were simultaneously put in the main hopper of an extrusion-molding machine (manufactured in the laboratory, L/D=10) through belt-type feeders K-TRON Nos. 1, 2 and 3, respectively, in a dry-blend state. Under the extrusion temperature condition of 210-225-235-235° C., the extrusion-molding process was performed to manufacture a 0.8 mm thick sheet.

### Comparative Example 1

A 0.8 thick sheet was manufactured in the same manner as in Example 1, except that organic montmorillonite as an intercalated clay was not used.

### Comparative Example 2

A 0.8 thick sheet was manufactured in the same manner as in Example 2, except that an organic montmorillonite as an intercalated clay was not used.

### Comparative Example 3

Only a styrene-based resin was extrusion-molded under the extrusion temperature condition of 240-265-265-265° C. to manufacture a sheet.

### Experimental Example

Gas Barrier property (cc/m², day, atm)

The sheet manufactured in Examples 1-5 and Comparative Examples 1-3 were left alone under a temperature of 23° C. and a relative humidity of 50% for 1 day. Then, the gas penetration rate was determined (Mocon OX-TRAN 2/20, U.S.A.).

TABLE 1
Barrier property of sheets

| | Oxygen | Moisture |
|---|---|---|
| | (cm²/m² · 24 hrs · atm) | (g/m² · 24 hrs) |
| Example 1 | 31.5 | 1.30 |
| Example 2 | 58.9 | 0.85 |
| Example 3 | 215.7 | 0.79 |
| Example 4 | 29.14 | 1.27 |
| Example 5 | 31.38 | 1.31 |
| Comparative Example 1 | 459.8 | 1.43 |
| Comparative Example 2 | 552.3 | 1.44 |
| Comparative Example 3 | 2124.6 | 1.37 |

As shown in Table 1, sheets of Examples 1 to 5 have a superior gas barrier property compared to those of Comparative Examples 1 to 3.

The nanocomposite composition according to an embodiment of the present invention has superior mechanical strength and moldability, and superior oxygen, organic solvent, and moisture barrier properties.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A dry-blended nanocomposite composition comprising:
40 to 98 parts by weight of a styrene-based resin;
0.5 to 60 parts by weight of at least one nanocomposite having a barrier property, selected from the group consisting of an ethylene-vinyl alcohol copolymer/intercalated clay nanocomposite, a polyamide/intercalated clay nanocomposite, an ionomer/intercalated clay nanocomposite and a polyvinylalcohol/intercalated clay nanocomposite; and
1 to 30 parts by weight of a compatibilizer.

2. The composition of claim 1, wherein the styrene-based resin is polystyrene (PS), styreneacrylonitrile (SAN) resin, or acrylonitrile-butadiene-styrene (ABS) resin.

3. The composition of claim 2, wherein the polystyrene is a general-purpose polystyrene (GPPS) or a high impact polystyrene (HIPS).

4. The composition of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

5. The composition of claim 1, wherein the intercalated clay comprises 1 to 45 wt % of an organic material.

6. The composition of claim 5, wherein the organic material has at least one functional group selected from the group consisting of from primary ammonium to quaternary ammonium, phosphonium, maleate, succinate, acrylate, benzylic hydrogen, dimethylstearylammonium, and oxazoline.

7. The composition of claim 1, wherein the ethylene-vinyl alcohol copolymer contains 10 to 50 mol % of ethylene.

8. The composition of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

9. The composition of claim 1, wherein the ionomer has a melt index of 0.1 to 10 g/10 min (190° C., 2,160 g).

10. The composition of claim 1, wherein the compatibilizer is at least one compound selected from the group consisting of a modified ABS resin having a functional group that can react with an amide group (—CO—NH), a styrene-maleimide copolymer, and an epoxy-modified polystyrene copolymer.

11. The composition of claim 10, wherein the modified ABS resin is methyl methacrylonitrile butadiene styrene or acrylonitrile butadiene methacrylic methylstyrene.

12. The composition of claim 1, wherein the weight ratio of the resin having a barrier property to the intercalated clay in the nanocomposite is 58.0:42.0 to 99.9:0.1.

13. An article manufactured by molding the nanocomposite composition of claim 1.

14. The article of claim 13, being a container, film, pipe, or sheet.

15. The article of claim 13, manufactured through blow molding, extrusion molding, pressure molding, or injection molding.
